(19) United States
(12) Patent Application Publication
(10) Pub. No.: US 2022/0283013 A1
(43) Pub. Date: Sep. 8, 2022

(54) Contact free foam sensing in closed vessels with resonant sensors

(71) Applicant: Skroot Laboratory, Inc., Ames, IA (US)

(72) Inventors: Nigel F. Reuel, Ames, IA (US); Cameron Greenwalt, Kalamazoo, MI (US); Samuel Rothstein, Ames, IA (US); Charu Gupta, Ames, IA (US)

(73) Assignee: Skroot Laboratory, Inc., Ames, IA (US)

(21) Appl. No.: 17/193,480

(22) Filed: Mar. 5, 2021

(51) Int. Cl. G01F 23/284; G01F 23/26

(52) U.S. Cl. CPC G01F 23/2845; G01F 23/265; G01F 23/266

(57) ABSTRACT

A system is provided for monitoring foam levels within a vessel wherein one or more chemical reactions or biological growths are occurring. The system includes a resonant sensor positioned outside of the vessel at a position to measure foam level within the vessel, the resonant sensor having an inductive element and a capacitive element and tuned to provide for enhanced sensitivity of changes in local permittivity to resonate. In a frequency range which permits penetration through a sidewall of the vessel, at least one antenna positioned outside of the vessel, a scattering parameter measurement device electrically connected to the at least one antenna positioned outside of the vessel to measure transmitted or reflected power, and a controller operatively connected to the scattering parameter measurement device to receive a signal from the scattering parameter measurement device, the controller configured to correlate resonant frequency based on the signal from the vector network analyzer with foam level in the vessel,

### STATEMENT REGARDING FEDERALLY SPONSORED RESEARCH

This invention was made with government support under Award 2025552 by the National Science Foundation. The government has certain rights in the invention.

### FIELD OF THE INVENTION

The present invention relates to non-contact sensing in a vessel. More particularly, but not exclusively, the present invention relates to contact free foam sensing using resonant sensors in closed vessels such as bioreactors or fermenters.

### BACKGROUND

In production processes such as, but not limited to, those involving fermentation, foaming is a normal occurrence. However, foaming, if left uncontrolled can have detrimental effect. Therefore, it is desirable to monitor foaming and, when needed, to reduce foaming such as through the addition of defoaming agents.

It would be desirable to measure level of foam from outside of the vessel without any product contact. Doing so would prevent contamination of the product. One approach that has been used is to include a viewport in the vessel and provide an optical sensor. However, there are limitations in this approach as such systems would be limited to specific vessels that have the correct transparency. What is needed is non-contact foam sensing for closed vessels which does not need a transparent window for detection.

Therefore, what is needed are new and improved non-contact systems and methods for sensing foam levels in vessels.

### SUMMARY

Therefore, it is a primary object, feature, or advantage of the present invention to improve over the state of the art.

It is a further object, feature, or advantage of the present invention to provide for contact free foam sensing in closed vessels.

It is a still further object, feature, or advantage of the present invention to provide for contact free foam sensing in dosed vessels without the disadvantages and limitations associated with a transparent window and optical sensing.

Another object, feature, or advantage is to provide for non-contact foam sensing suitable for use with a glass or plastic vessel (or steel vessel with glass viewport).

Yet another object, feature, or advantage is to provide an apparatus, method, and system which may be used in food, pharmaceutical, chemical, and waste treatment industries.

A still further object, feature, or advantage is to provide for adding de-foaming agents to a mixture in order to decrease foam levels.

Another object, feature, or advantage is to correlate liquid level and/or foam level with electrical sensor measurements.

Yet another object, feature, or advantage is to provide improved process control, increased yield, and/or reduced product loss due to foam

Yet another object, feature, or advantage is to reduce equipment failure related to foaming.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, a system includes a vessel, a resonant sensor positioned outside of the vessel at a position to measure foam level within the vessel, the resonant sensor having an inductive element and a capacitive element and tuned to provide for enhanced sensitivity of changes in local permittivity to resonate in a frequency range which permits penetration through a sidewall of the vessel, at least one antenna positioned outside of the vessel, a vector network analyzer electrically connected to the at least one positioned outside of the vessel to measure reflected or transmitted power across the frequency range, and a controller operatively connected to the vector network analyzer to receive a signal from the vector network analyzer indicative of the reflected or transmitted power across the frequency range. The controller is configured to correlate resonant frequency based on the signal from the vector network analyzer with foam level in the vessel. The system may further include a de-foaming agent dispensing system electrically connected to the controller for dispensing dc-foaming agent based on the foam n level. The controller may be configured to dispense a dose of the de-foaming agent after the foam level in the vessel has reached a threshold. The de-foaming agent dispensing system may include an as actuator, the actuator electrically connected to the controller. The actuator may control a valve. The resonant sensor may include a planar Archimedean coil. The at least one antenna may be pair of antennas and each of the pair of antennas may be a loop antenna and the scattering parameter measurements include S21 measurements. The resonant frequency may correlate to the foam level in the vessel according to a linear function. The frequency range may be within a range of 1 to 150 MHz. The resonant sensor may further include a flexible substrate and wherein the inductive element and the capacitive element are attached to the flexible substrate. The vessel may be a closed vessel and may be a bioreactor.

According to another aspect, a system for monitoring foam levels within a vessel wherein one or more chemical reactions or biological growth processes are occurring, the system includes a resonant sensor positioned outside of the vessel at a position to measure foam level within the vessel, the resonant sensor having an inductive element and a capacitive element and tuned to provide for enhanced sensitivity of changes in local permittivity to resonate in a frequency range which permits penetration through a sidewall of the vessel, at least one antenna positioned outside of the vessel, a scattering parameter measurement device electrically connected to the at least one antenna positioned outside of the vessel to provide scattering parameter measurements, and a controller operatively connected to the scattering parameter measurement device to receive a signal from the scattering parameter measurement device, the signal containing one of more scattering parameters. The controller is configured to correlate resonant frequency based on the signal from the vector network analyzer with foam level in the vessel.

According to aspect, a method for determining level of foam within a vessel is provided. The method includes positioning a resonant sensor outside of the vessel at a location for determining the level of foam within the vessel, the resonant sensor having an inductive element and a capacitive element, interrogating the resonant sensor with at least one antenna positioned outside of the vessel, measuring an amount of transmitted or reflected power by the at least one antenna, determining resonant frequency shift using the amount of transmitted or reflected power over time, correlating by a controller the resonant frequency shift with the level of foam within the vessel to determine the level of foam within the vessel, and performing an action based on the level of foam within the vessel if the level of foam within the vessel exceeds a threshold.

According to another aspect, a system includes a vessel, a resonant sensor positioned outside of the vessel at a position to measure foam level within the vessel, the resonant sensor having an inductive element and a capacitive element and tuned to provide for enhanced sensitivity of changes in local permittivity to resonate in a frequency range which permits penetration through a sidewall of the vessel, at least one antenna positioned outside of the vessel, a scattering parameter measurement device electrically connected to the at least one antenna positioned outside of the vessel to measure reflected or transmitted power across the frequency range, and a controller operatively connected to the scattering parameter measurement device to receive a signal from the scattering parameter measurement device indicative of the reflected or transmitted power across the frequency range. The controller is configured to correlate resonant frequency based on the signal from the scattering parameter measurement device with foam level in the vessel.

According to another aspect, a system provides for monitoring foam levels within a vessel wherein one or more chemical reactions are occurring. The system includes a resonant sensor positioned outside of the vessel at a position to measure foam level within the vessel, the resonant sensor having an inductive element and a capacitive element and tuned to provide for enhanced sensitivity of changes in local permittivity to resonate in a frequency range which permits penetration through a sidewall of the vessel. The system further includes a single antenna or pair of antennas positioned outside of the vessel to inductively couple with the sensor. The system further includes a vector network analyzer electrically connected to the single antenna or pair of antennas positioned outside of the vessel to measure reflected or transmitted power, respectively. The system flintier includes a controller operatively connected to the vector network analyzer to receive a signal from the vector network analyzer. The controller is configured to correlate resonant frequency based on the signal from the vector network analyzer with foam level in the vessel. The system may further include a de-foaming agent dispensing system electrically connected to the controller for dispensing de-foaming agent based on the foam level. The controller may be configured to dispense a dose of the de-foaming agent after the foam level in the vessel has reached a threshold. The de-foaming agent dispensing system may include actuator, the actuator electrically connected to the controller. The actuator may control a valve. The resonant sensor may include a planar Archimedean coil. Each of the antennas may be a loop antenna. The resonant frequency may correlate to the foam level in the vessel according to a linear function. The frequency range may be within a range of 1 to 150 MHz. The resonant sensor may further include a flexible substrate and wherein the inductive element and the capacitive element are attached to the flexible substrate. The vessel may be a closed vessel and/or a bioreactor.

According to another aspect, a method for determining level of foam within a vessel is provided. The method may include positioning a resonant sensor outside of the vessel at a location for determining the level of foam within the vessel, the resonant sensor having an inductive element and a capacitive element. The method may further include interrogating the resonant sensor with a pair of antennas positioned outside of the vessel. The method may further include measuring an amount of transmitted power by the pair of antennas using a vector network analyzer. The method may further include determining resonant frequency shift using the amount of transmitted power over time, correlating by a controller the resonant frequency shift with the level of foam within the vessel to determine the level of foam within the vessel, and performing an action based on the level of foam within the vessel if the level of foam within the vessel exceeds a threshold. The action may include dispensing a de-foaming agent into the vessel to reduce the level of foam within the vessel. The correlating by the controller may be performed using a linear transfer function. The resonant sensor may include a planar Archimedean coil. The resonant frequency shift may occur during a chemical reaction such as a fermentation reaction occurring within the vessel. The vessel may be a closed vessel.

According to another aspect, a system is provided. The system includes a vessel. The system further includes a resonant sensor positioned outside of the vessel at a position to measure foam level within the vessel, the resonant sensor having an inductive element and a capacitive element and tuned to provide for enhanced sensitivity of changes in local permittivity to resonate in a frequency range which permits penetration through a sidewall of the vessel. The system further includes a pair of antennas positioned outside of the vessel. The system further includes a vector network analyzer electrically connected to the pair of antennas positioned outside of the vessel to measure transmitted power. The system further includes a controller operative connected to the vector network analyzer to receive a signal from the vector network analyzer. The controller may be configured to correlate resonant frequency based on the signal from the vector network analyzer with foam level in the vessel.

### BRIEF DESCRIPTION OF THE DRAWINGS

Illustrated embodiments of the disclosure are described in detail below with reference to the attached drawing figures., which are incorporated by reference herein.

FIG. 1A is a representation of a system for determining fluid level in a closed vessel using a non-contact sensor.

FIG. 1B is a S21 curve showing transmission power (dB) for different frequencies (MHz) for the system shown in FIG. 1A.

FIG. 2A is a representation of the system for determining foam level in the closed vessel using the non-contact sensor.

FIG. 2B is a S21 curve showing transmission power (dB) for different frequencies (MHz) for the system shown in FIG. 2A.

FIG. 3 illustrates resonant frequency in MHz for time to show that as the foam level rises. the resonant frequency decreases and as the foam level decreases the resonant frequency increases.

FIG. 4 shows a linear regression correlating the resonant frequency (MHz) to the sensor coverage (percentage).

FIG. 5 illustrates that when the sensor is positioned below the liquid line, the resonant frequency of the sensor is independent of mixing unless the relative air flow is so significant that the liquid approximates a foaming event.

FIG. 6 is a diagram illustrating a control system which controls the addition of a defoamer to a vessel based on sensor readings from a resonant sensor.

FIG. 7 is a flow diagram illustrating one example of a methodology for sensing and controlling foam level within a closed vessel where a reaction is occurring.

FIG. 8 further illustrates the resonant sensor.

### DETAILED DESCRIPTION

Foam has a different relative permittivity than its origin fluid. As explained herein, this property is exploited for contact free sensing in a closed vessel using an optimized inductor capacitor (LC) resonant circuit The LC circuit may be a planar Archimedean coil that is tuned for enhanced sensitivity of changes in local permittivity, it may be placed on the outside of a plastic or glass vessel. Alternatively, it may be placed on a glass window of a steel vessel. The presence of foam on the inside then shifts the resonant frequency, which may be measured by one or two antennas coupled to a vector network analyzer placed in proximity to the sensor.

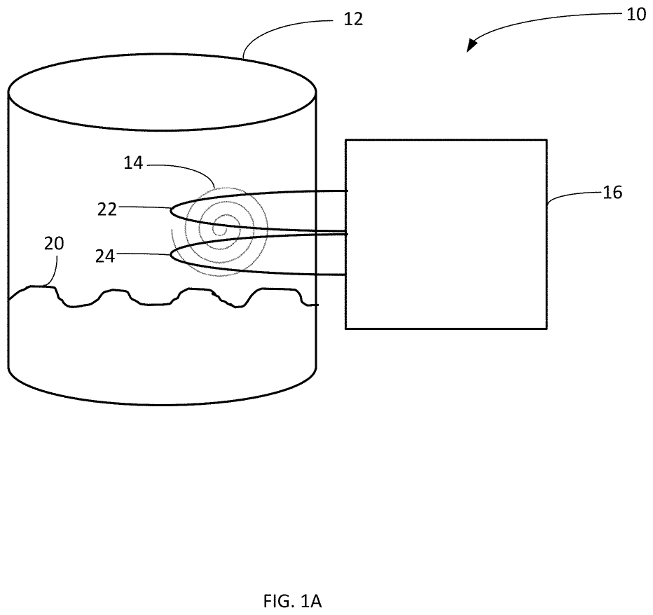

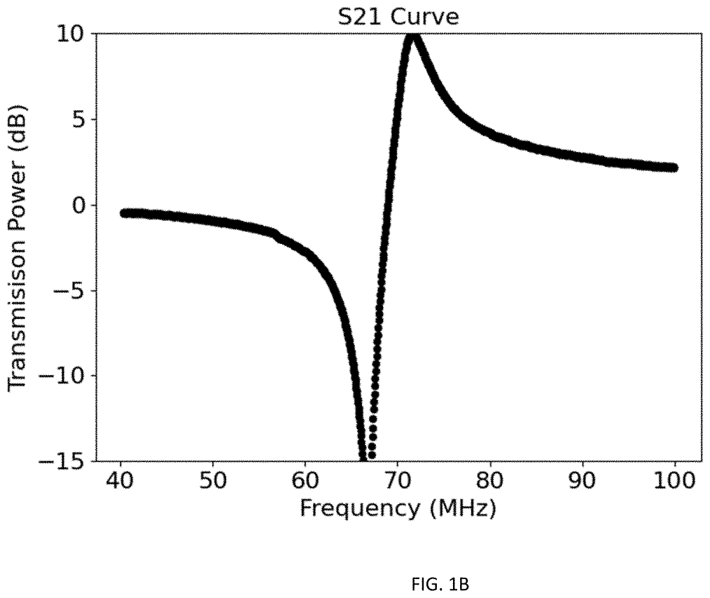

FIG. 1A is a representation of a system 10 for determining fluid level in a closed vessel 12 using a non-contact sensor 14. The non-contact sensor 14 is in the form of a resonant sensor patch that may be placed on the outside of a vessel such as a plastic vessel, or glass vessel in order to evaluate the level of foam present in the vessel. Note that in FIG. 1A, the sensor 14 is positioned above the liquid level 20.

It is to be understood that such a system may be desirable in any number of different applications and may be especially relevant in food, pharmaceutical, chemical, and waste treatment industries and in other applications where it is undesirable to contaminate a fluid within the vessel by exposing it to sensor probes.

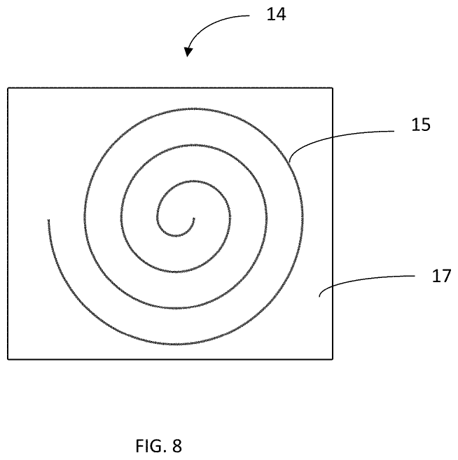

The sensor 14 may be an inductor capacitor (LC) sensor that is tuned to resonate in the 1-150 MHz range to achieve a maximum penetration distance through the sidewall of the vessel and into the solution. The sensor 14 may be formed using a planar Archimedean coil. FIG. 8 illustrates the sensor 14 including the planar Archimedean coil 15 and a substrate 17. Returning to FIG. 1, the sensor 14 may be interrogated by one or two antennas 22, 24, which may both be loop antennas, in order to measure the amount of reflected or transmitted power (S11 or 521 magnitude, respectively) using a scattering parameter measurement device 16 such as a vector network analyzer (VNA). It is to be understood that where reflected power (S11) is used, only a single antenna is required and where transmitted power (S21) is used, two antennas are used. Thus, the sensor 14 in combination with the scattering parameter measurement device 16 and one or more antennas may be used to determine scattering parameters or s-parameters. Although a VNA is one example of a scattering parameter device it is to be understood that other types of devices or systems may be used which provide for measurement of scattering parameters such as other types of network analyzers or other types of systems which generate a signal across a range as of frequencies and determine scattering parameters such as S11 or S21 parameters. The sensor 14 may be constructed by screen-printing a conductive trace or etching copper to form the coil on a flexible substrate (such as polyimide). There is a characteristic frequency at which the level of transmitted power is increased (resonant frequency) that is dictated by the sensor geometry and local environmental conditions. The lumped capacitance term of the sensor 14 is affected by the local relative permittivity. Thus, changes in foam level will change the lumped capacitance term.

The scattering parameter measurement device 16 may be implemented as a two loop VNA coupled to loop antennas 22, 24 as shown. The VNA is thus configured to measure an amount of signal power (dB) transmitted and absorbed through the resonator sensor 14 for a range of different frequencies. Alternatively, where reflected power is used, only a single antenna need be coupled to the VNA.

FIG. 1B shows the transmitted power (S21 magnitude) across a range of frequencies as obtained using the system shown in. FIG. 1A. Note that the level of transmitted power is sharply increased at a resonant frequency around 70 MHz and then reduces thereafter.

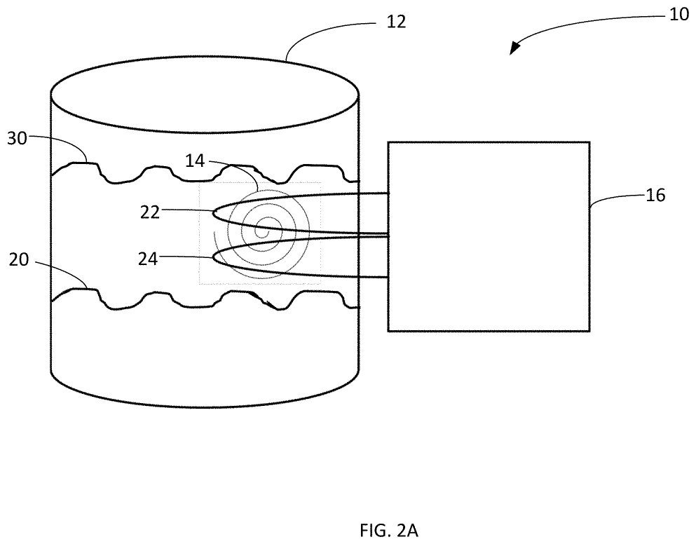

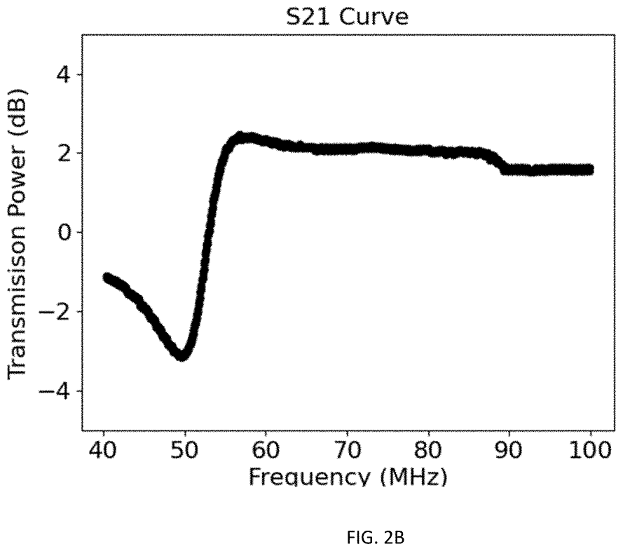

FIG. 2A illustrates the same system 10 as shown in FIG. 1 except now, above the liquid level 20 is a foam level 30. Note that the sensor 14 is positioned such that the sensor 14 is above the liquid level and below the top of the vessel.

FIG. 213 shows the transmitted power (S21 magnitude) across a range of frequencies as obtained using the system shown in FIG. 2A. Note that the level of transmitted power is sharply increased at a resonant frequency around 55 MHz and then levels off for the rest of the given frequency range.

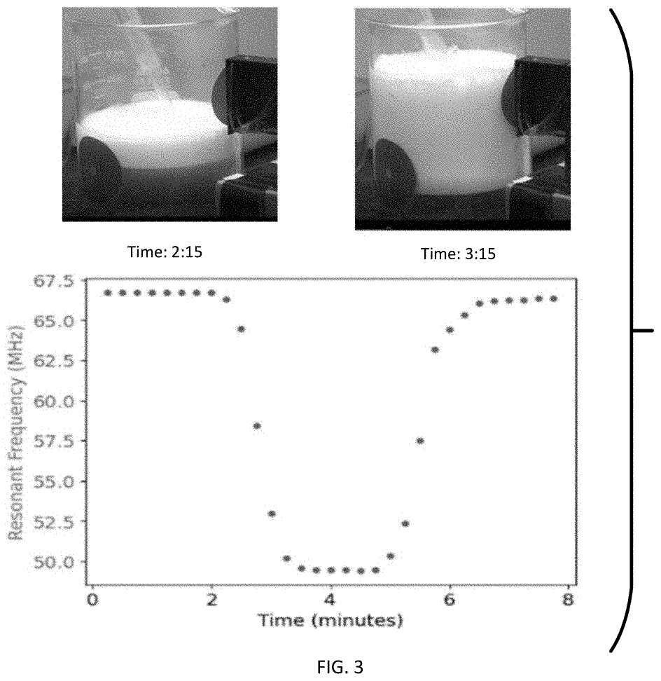

FIG. 3 shows that as the foam level rises the relative permittivity increases (shifting from air to an air-water mix) and the resonant frequency decreases. This signal is readily reversible when de-foaming agent is added.

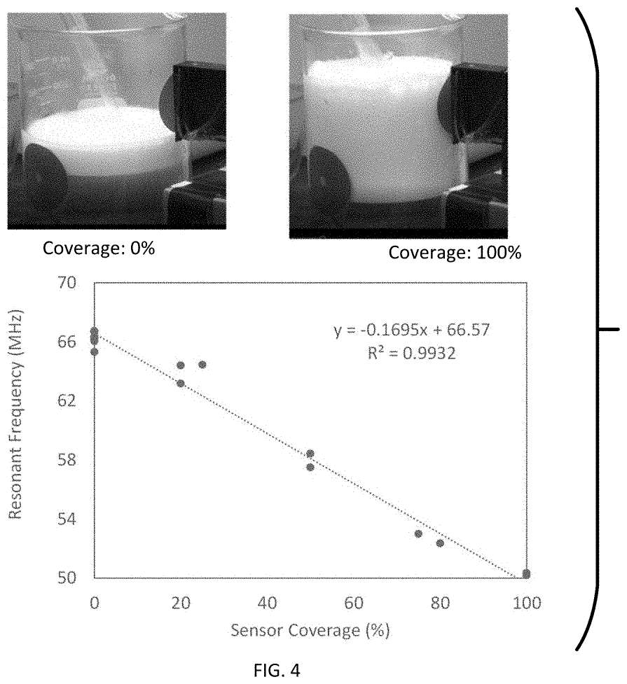

FIG. 4 further illustrates that there is a strong linear correlation between foam level and resonant frequency shift. When the level of foam in the vessel is below the sensor there is 0 percent sensor coverage. When the level of foam extends to the top of the sensor (or above) there is 100 percent sensor coverage. Thus, the percentage of sensor coverage may be as determined from the linear relationship between the percent of sensor coverage and resonant frequency as determined using the sensor. In this example, the coefficient of determination is computed to be 0.9932 indicative that the linear regression equation may be used to accurately determine foam level.

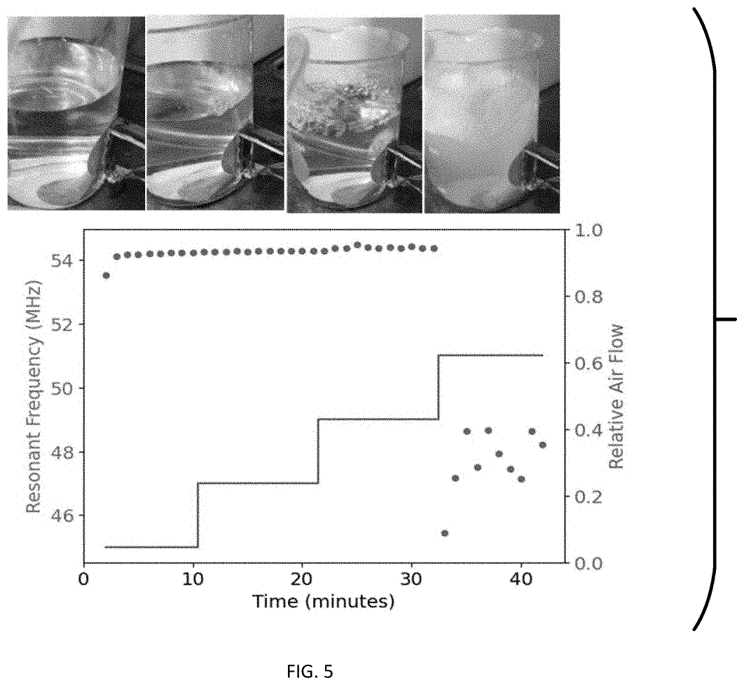

When placed below the liquid line, the sensor signal is independent of mixing, unless the aeration is so strong that the liquid again approximates a foaming event as shown in FIG. 5. Thus, the sensor should preferably be placed at or above the liquid line.

It is contemplated that the size of the sensor may selected to cover a larger range of foaming levels. It is also contemplated that the same vessel may have more than one sensor present such as having one sensor positioned above another and only one of the sensors would need to be used at a time, depending, upon the foam level. Generally, however, a single sensor is sufficient placed at an appropriate location so as to determine if foam level reaches a particular threshold. Once foam level reaches a particular threshold then actions may be taken such as the addition of a defoaming agent.

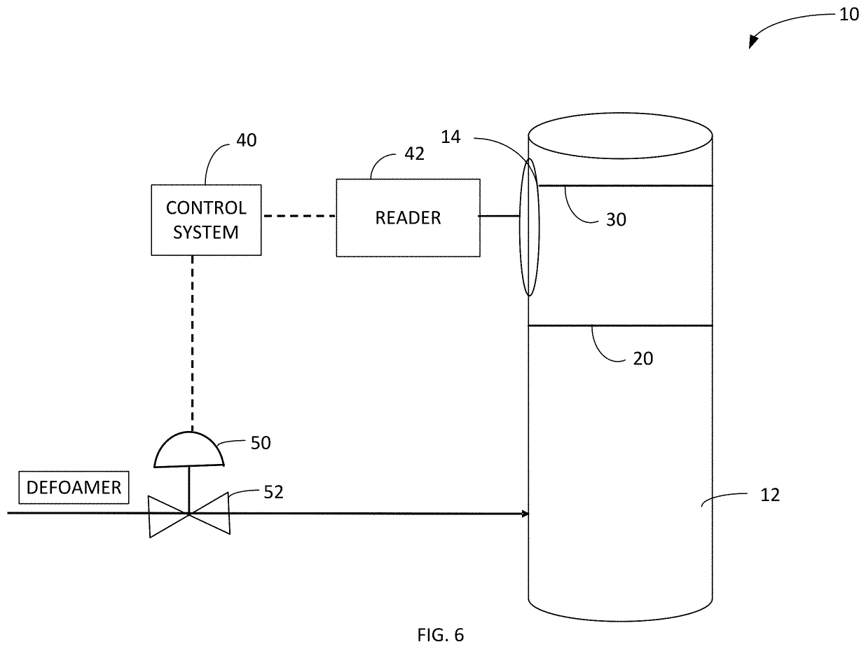

FIG. 6 illustrates one example of a system which provides for the addition of a defaming agent. A closed vessel 12 is shown such as used for a reactor Liquid or solution extends to the liquid level 20 and foam extends to the foam level 30. A control system 40 is operatively connected to an interrogator or reader 42 which is used to interrogate the resonant sensor patch 14. The control system may be a single board computer or other type of processing device, logic circuit, or other type of intelligent control. One type of control system which may be used is a PID control system. The control system 40 may correlate the resonant frequency with the foam level such as being programmed to use a linear correlation between the two. Then, based on the foam level a defoaming agent may be added. For example, an actuator 50 may actuate a valve 52 to release a defoaming agent such as an alcohol or glycol. If the level of foam exceeds a threshold then a set amount or dose of the defoaming agent may be added. Alternatively, a determination of the amount of defoaming agent to add may be made based on the level of foam at a particular time.

It is to be further understood that other actions may be taken instead of adding a defoaming agent. For example, where an agitator is being used within the, vessel, in order to reduce foam level, the speed of the agitator may be reduced in order to reduce foaming if the level of foam exceeds a particular threshold. Alternatively, a portion of the tank volume could be removed to bring the level back to safe operation.

It is also to be understood that the level of foam may be combined with other sensor readings such as temperature sensor readings, gas sensor readings, or other sensor readings used to monitor a reaction, the environment, or other data of interest in order to provide fore better process control and optimization. For example, both the level of the foam and the time at which the level of the foam is measured or other data indicative of the progression of the reaction may be used in determining the appropriate action to be taken such as the amount of defoaming agent to dose.

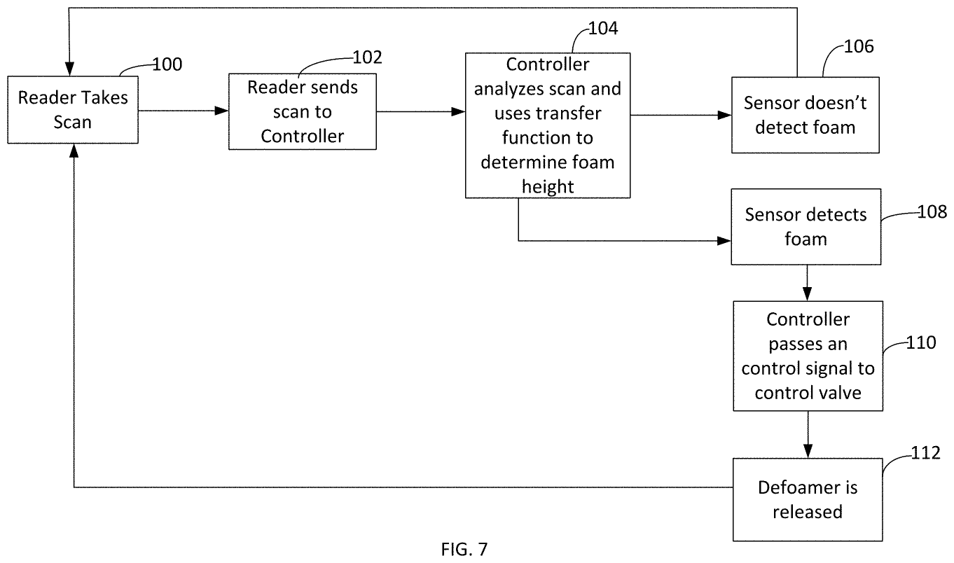

FIG. 7 illustrates one example of method which may be performed by the system. In step 100 a reader takes a scan. In step 102, the reader sends the scan to a controller such as a single hoard computer or other type of computing; device or intelligent control. The controller then analyzes the scan. One form of analysis may be to apply a transfer function in order to determine the foam height or live within the vessel. If in step 106, the sensor does not detect foam present, then the process may be repeated with the reader taking another scan in step 100. If the reader detects foam present in step 108 then the control system may, in step 110 pass a control signal so that in step 112 the defoamer is released. The control signal may be an analog signal and may be used to activate a control valve or other actuator for releasing the de-foaming agent.

Thus, it should be understood that foam level within a vessel may be sensed through a resonant sensor placed outside of a vessel and once sensed, foam level may be controlled by action such as adding a de-foaming agent.

The invention is not to be limited to the particular embodiments described herein. In particular, the invention contemplates numerous variations in the structure of the resonant sensor, the range of frequencies associated with the resonant sensor, the composition and geometry of the resonant sensor, variations in the number of antenna and the antenna structure, variations in the manner in which resonant frequency is correlated with a foam level, variations in the actions which may be taken in response to determining a particular level of foam, variations in the type of scattering parameter measurement device used, and other variations. The foregoing description has been presented for purposes of illustration and description. It is not intended to be an exhaustive list or limit any of the invention to the precise forms disclosed. It is contemplated that other alternatives or exemplary aspects are considered included in the invention. The description merely provides examples of embodiments, processes, or methods of the invention. It is understood that any other modifications, substitutions, and/or additions can be made, which are within the intended spirit and scope of the invention.

What is claimed is:

1. A system for monitoring foam levels within a vessel wherein one or more chemical reactions or biological growth processes are occurring, the system comprising:
a resonant sensor positioned outside of the vessel at a position to measure foam level within the vessel, the resonant sensor having an inductive element and a capacitive element and tuned to provide for enhanced sensitivity of changes m local permittivity to resonate in a frequency range which permits penetration through a sidewall of the vessel;
at least one antenna positioned outside of the vessel;
a scattering parameter measurement device electrically connected to the at least one ante a positioned outside of the vessel to provide scattering parameter measurements;
a controller operatively connected to the scattering parameter measurement device to receive a signal from the scattering parameter measurement device, the signal containing one of more scattering parameters;
wherein the controller is configured to correlate resonant frequency based on the signal from the vector network analyzer with foam level in the vessel.

2. The system of claim 1 further comprising a de-foaming agent dispensing system electrically connected to the controller for dispensing de-foaming agent based on the foam level.

3. The system of claim 2 Wherein the controller is configured to dispense a dose of the de-foaming agent alter the foam level in the vessel has reached a threshold.

4. The system of claim 3 wherein the de-foaming agent dispensing system comprises an actuator, the actuator electrically connected to the controller.

5. The system of claim 4 wherein the actuator controls a valve.

6. The system s of claim 1 wherein the resonant sensor comprises a planar Archimedean coil.

7. The system of claim 1 wherein the at least one antenna is a pair of antennas, each of the pair of antennas is a loop antenna and wherein the scattering parameter measurements include S21 measurements.

8. The system of claim 1 wherein the resonant frequency correlates to the foam level in the vessel according to a linear function.

9. The system of claim 1 wherein the frequency range is within a range of 1 to 150 MHz.

10. The system of claim 1 wherein the resonant sensor farther comprises a flexible substrate and wherein the inductive element and the capacitive element are attached to the flexible substrate.

11. The system of claim 1 wherein the vessel is a closed vessel.

12. The system of claim 1 wherein the vessel is a bioreactor.

13. A method for determining level of foam within a vessel, the method comprising:
positioning a resonant sensor outside of the vessel at a location for determining the level of foam within the vessel, the resonant sensor having an inductive element and a capacitive element;
interrogating the resonant sensor with at least one antenna positioned outside of the vessel;
measuring an amount of transmitted or reflected power by the at least one antenna;
determining resonant frequency shift using the amount of transmitted or reflected power over time;
correlating by a controller the resonant frequency shift with the level of foam within the vessel to determine the level of foam within the vessel; and
performing an action based on the level of foam within the vessel if the level of foam within the vessel exceeds a threshold.

14. The method of claim 13 wherein the action comprises dispensing a de-foaming agent into the vessel to reduce the level of foam within the vessel.

15. The method of claim 13 wherein the correlating by the controller is performed using a linear transfer function.

16. The method of claim 13 wherein the resonant sensor comprises a planar Archimedean coil.

17. The method of claim 13 wherein the determining the resonant frequency shift occurs during a chemical reaction within the vessel.

18. The method of claim 13 wherein the determining the resonant frequency shift occurs during a fermentation being performed within the vessel.

19. The method of claim 13 wherein the vessel is a closed vessel.

20. A system comprising:
a vessel;
a resonant sensor positioned outside of the vessel at a position to measure foam level within the vessel, the resonant sensor having an inductive element and a capacitive element and tuned to provide for enhanced sensitivity of changes in local permittivity to resonate in a frequency range which permits penetration through a sidewall of the vessel;
at least one antenna positioned outside of the vessel;
a scattering parameter measurement device electrically connected to the at least one antenna positioned outside of the vessel to measure reflected or transmitted power across the frequency range;
a controller operatively connected to the scattering parameter measurement device to receive a signal from the scattering parameter measurement device indicative of the reflected or transmitted power across the frequency range;
wherein the controller is configured to correlate resonant frequency based on the signal from the scattering parameter measurement device with foam level in the vessel.
